(19) United States
(12) Patent Application Publication
(10) Pub. No.: US 2009/0211153 A1
(43) Pub. Date: Aug. 27, 2009

(54) Aquapac

(75) Inventors: Trent A. Harshman, Galveston, IN (US); Troy L. Burnette, Greentown, IN (US); Pawan Srivastava, Kokomo, IN (US)

Correspondence Address: Frank D. Lanchenmaier, 116 N. Main St., P. O. Box 1047, Kokomo, IN, 46903-1047, US

(73) Assignee: Syndicate Sales, Inc., Kokomo, IN (US)

(21) Appl. No.: 12/387,342

(22) Filed: May 1, 2009

Related U.S. Application Data
(63) Continuation-in-part of application No. 11/397,030, filed on Mar. 31, 2006.

(51) Int. Cl. A01G 5/00; A01G 9/02; A47G 7/02

(52) U.S. Cl. 47/66.7

(57) ABSTRACT

The present invention relates generally to a method for shipping flowers that provides moisture and nutrients to the flowers during shipping which significantly increases their life expectancy and provides protection to the fragile stem ends against handling damage.

### CROSS REFERENCE TO RELATED APPLICATIONS

This application is a Continuation-in-part of parent application Ser. No. 11/397,030 which is hereby abandoned.

### BACKGROUND

1. Field of Invention

The present invention relates generally to an apparatus for preparing and shipping fresh cut flowers that provides moisture and nutrients to the cut flowers during shipping which significantly increases their life expectancy and a method of using same.

2. Prior Art

U.S. Pat. No. 3,552,059 Moore 1971 disclosed a block of absorbent floral foam enclosed in a cardboard box with a large opening at the top that is covered by a thin, flower stem penetrable plastic film. The foam is soaked in water and flower stems are individually punched through the film and into the water soaked foam. This system is prone to leakage and is limited in that the flowers must be individually inserted, the boxes and film are expensive to make and time consuming to use and the foam dries up over time.

U.S. Pat. No. 5,115,915 Harris 1992 attempts to resolve these problems by providing a water filled or a water-soaked-foam filled container or vase with flower stems inserted and a rigid non-absorbent plug or cap foamed in place around the flower stems sealing the water in the bottom of the container. This system is also relatively expensive and time consuming.

200510138862 O'Conner 2005 discloses another approach to solving the problem of moisture leaking from a water well. Flower stems are inserted through openings in a flexible foam block that are slightly larger than the flower stems in question. The flexible foam block is positioned above the water surface. After the flower stems are individually inserted into their assigned channels the ring is radially compressed, sealing each stem in its own passage way. Again this is a very time consuming process and an expensive system to utilize.

U.S. Pat. No. 5,335,475 Weder 1994 discloses a simpler, less expensive system by providing a sheet of moisture absorbing and releasing material to be soaked in water and wrapped around a group of cut flower stems and secured with a rubber band. This product often allows the flower stems in the center of a bundle to be out of contact with the moisture-carrying sheet of material or crushed by rough handling or packing and allows the onset of stenosis before the flowers reach their destination.

### SUMMARY OF THE INVENTION

An object of the AQUAPAC is to provide a leak free apparatus and a method of using same for providing moisture at the cut end of the stems of flower bundles during shipping.

A further object of the AQUAPAC is to provide a leak free apparatus and a method of using same for providing moisture at the cut end of the stems of flower bundles during shipping that allows a single flower stem or the full bundle to be entered into the moisture carrying medium with just one insertion.

A further object of the AQUAPAC is to provide a leak free apparatus and a method of using same for providing moisture at the cut end of the stems of flower bundles during shipping wherein the moisture carrying medium is encased on all sides and the perimeter of the bottom with an impervious barrier, leaving the top surface open for floral insertion and the center of the bottom surface open for drainage of excess moisture before bagging.

A further object of the AQUAPAC is to provide a leak free apparatus and a method of using same for providing moisture at the cut end of the stems of flower bundles during shipping wherein various sizes and shapes of moisture carrying medium apparatus are provided for different sizes and groupings of flowers.

A further object of the AQUAPAC is to provide a leak free apparatus and a method of using same for providing moisture at the cut end of the stems of flower bundles during shipping wherein the flower stems are inserted into the moisture carrying medium and soaked in water until moisture carrying medium is saturated and flower stems have absorbed all the moisture they can and are packaged for shipping in an economic and efficient process.

A further object of the AQUAPAC is to provide a leak free apparatus and a method of using same for providing moisture at the cut end of the stems of flower bundles during shipping wherein the moisture carrying medium is highly compressible or crushable, reducing landfill disposal requirements.

A further object of the AQUAPAC is to provide a leak free apparatus and a method of using same for providing moisture at the cut end of the stems of flower bundles during shipping wherein the cut ends of the flower stems to be shipped are protected from bruising or crushing that would block the flow of fluid into the cut ends of the stems.

A further object of the AQUAPAC is to provide a leak free apparatus and a method of using same for providing moisture at the cut end of the stems of flower bundles during shipping wherein the moisture carrying medium is not crushed by the insertion of the cut flower stems either by providing clearance wells or by giving the displaced material room to move and floral foam block stability is enhanced by the banding effect of shrink wrapping the perimeter walls or encasing in a plastic box.

The present invention in its various embodiments, meets the above mentioned objectives.

Still further objects and advantages will become apparent from a consideration of the ensuing description and accompanying drawings. In the description, reference is made to the accompanying drawings which form a part thereof, and in which are shown, by way of illustration, four exemplary embodiments in which the invention may be practiced. These embodiments will be described in sufficient detail to enable those skilled in these arts to practice this invention, and be understood that other embodiments may be utilized and that structural changes may be made without departing from the scope of the invention. In the accompanying drawings, like reference characters designate the same or similar parts throughout the several views.

### DRAWINGS

The invention is described with reference to the following drawings:

FIG. 1A is a top perspective view of a floral foam cylindrical block;

FIG. 1B is a top perspective view of a floral foam cylindrical block with stem clearance wells;

FIG. 1C is a top perspective view of a plastic film sleeve shrink wrapped cylindrical floral foam block with stem wells;

FIG. 1D is a bottom perspective view of a plastic film sleeve shrink wrapped cylindrical floral foam block;

FIG. 1E is a bottom perspective view of a seal and shrink wrapped cylindrical floral foam block without a drain hole in the bottom surface;

FIG. 1F is a bottom perspective view of a seal and shrink wrapped cylindrical floral foam block with a drain hole in the bottom surface;

FIG. 1G is a top perspective view of cylindrical case and lid with a cylindrical block of floral foam inserted;

FIG. 1H is a top perspective view of cylindrical case and lid with a cylindrical block of floral foam with stem wells inserted;

FIG. 1J is a bottom perspective view of a cylindrical case and lid assembly without a drain hole;

FIG. 1K is a bottom perspective view of a cylindrical case and lid assembly with a block of floral foam inserted with a drain hole;

FIG. 2A is a top perspective view of a floral foam cubical block;

FIG. 2B is a top perspective view of a floral foam cubical block with stem clearance wells;

FIG. 2C is a top perspective view of a seal and shrink wrapped cubical floral foam block with stem clearance wells;

FIG. 2D is a bottom perspective view of a seal and shrink wrapped cubical floral foam block;

FIG. 2E is a bottom perspective view of a seal and shrink wrapped cubical floral foam block with drain hole;

FIG. 2F is a top perspective view of a cubical plastic case with lid and a cubical block of floral foam inserted;

FIG. 2G is a top perspective view of a cubical plastic case with lid and a cubical block of floral foam with stem clearance wells inserted;

FIG. 2H is a bottom perspective view of a cubical plastic case and lid assembly without a drain hole;

FIG. 2J is a bottom perspective view of a cubical plastic case, lid and block of floral foam assembly with a drain hole;

FIG. 3 is a top perspective view showing a bundle of cut flower stems inserted into a cylindrical floral foam block;

FIG. 4 is a front view of a foam block with a bundle of flower stems inserted being soaked in a moisture loading tank; and

FIG. 5 is a perspective view of a soaked foam cylindrical block with flower stems inserted in a plastic bag with packets of preservative attached to the outside of the top of the bag by fasteners.

### REFERENCE NUMBERS

The same reference numbers are used to refer to the same or similar parts in the various views.
12—Aquapac System
14—cylindrical floral foam block
16—cubical floral foam block stem
18—plastic film sleeve shrink wrap
20—plastic film seal and shrink wrap
22—cut flower stems
24—plastic bag
26—bag top fasteners
28—soak tank
30—foam block top surface
32—foam block bottom surface
34—foam block perimeter wall
36—flower bundle
38—preservative packets
40—preservative solution
42—lid
44—can or box
45—can or box with drain hole
46—stem wells
48—can or box encasement
50—can or box encasement with stem wells
52—excess fluid drain hole
54—plastic film sleeve shrink wrap encasement
56—plastic film seal and shrink wrap without drain hole encasement
57—plastic film sleeve shrink wrap with stem wells encasement
58—plastic film seal and shrink wrap with stem wells encasement
59—plastic film seal and shrink wrap with drain hole
60—can or box without drain hole encasement
62—can or box with drain hole encasement
64—stem clearance opening in lid

### DESCRIPTION

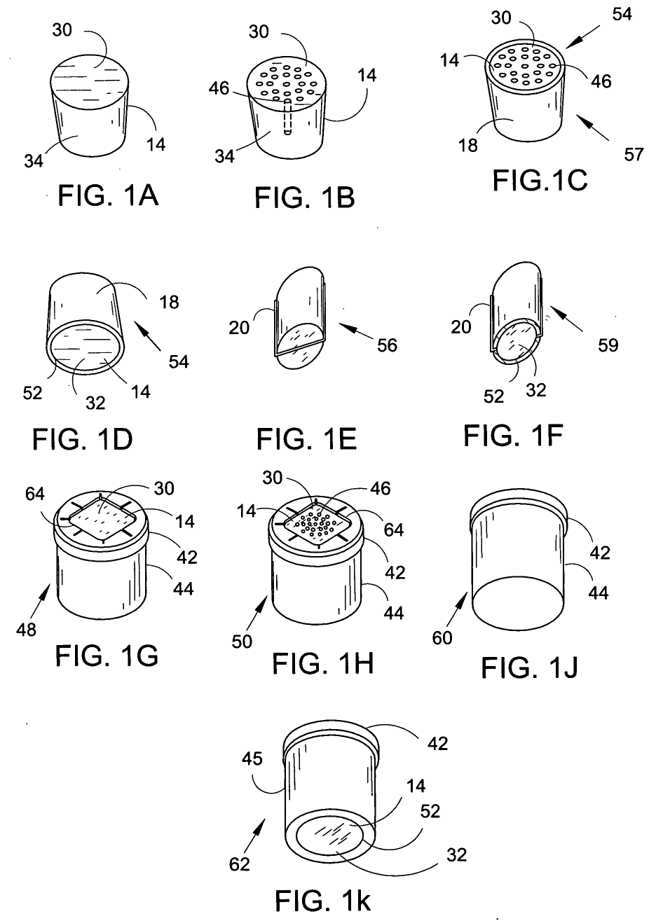

Four embodiments of Aquapac 12 will now be described, by way of example, with reference to the accompanying FIGS. 1A through 5.

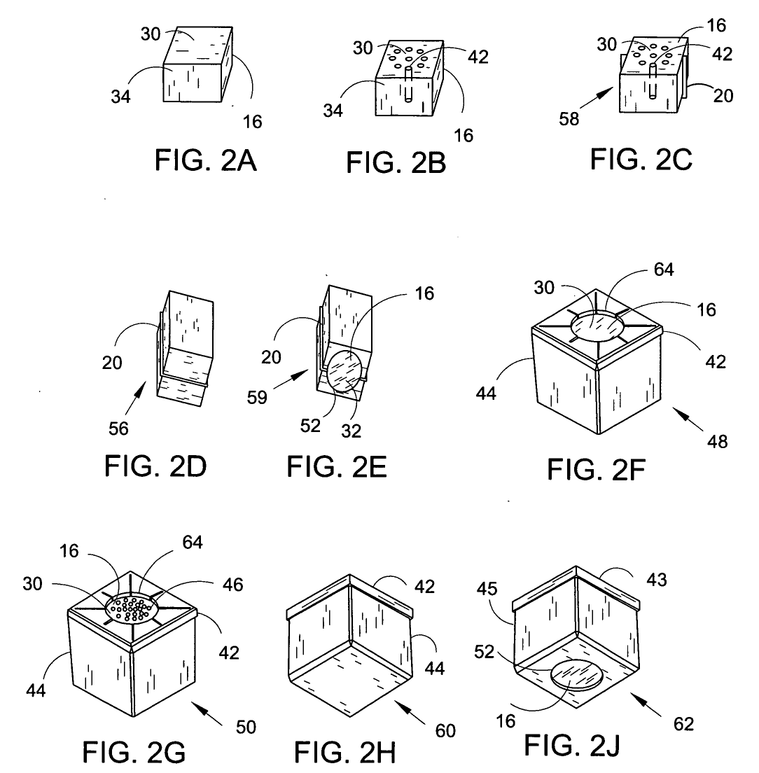

The first preferred embodiment is shown in FIGS. 1A and 2A and 3-5. FIGS. 1A and 2A show floral foam blocks 14 and 16 in cylindrical and cubic shapes respectively. Floral foam blocks 14 and 16 can be cut from an extruded block of fine open cell floral foam such as AQUAFOAM® from Syndicate Sales, Inc. in Kokomo, Ind., in various predetermined diameter or diagonal dimensions. Blocks 14 and 16 are sized to have sufficient cross-sectional areas to receive cut flower stems 22 of the desired size shipping flower bundle 36. They also are_sized to contain sufficient moisture carrying capabilities to provide the moisture and or nutrients required to allow flower bundles 36 to arrive at their destinations in a hydrated state. Blocks made from this material crush to a powder form, dramatically reducing landfill disposal requirements.

### Operation:

Foam blocks 14 or 16, plastic bags 24, preservative packets 38 and bag top fasteners 26 are delivered to florist or wholesaler for use in packaging flowers to maximize their life expectancy.

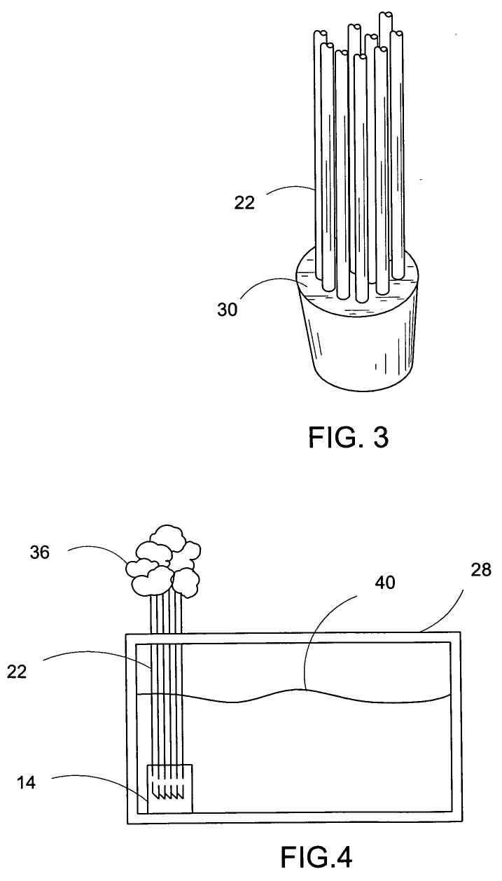

Cut flower stems 22 are inserted through foam block top surface 30 as shown in FIG. 3 to a depth of approximately 50 percent of the thickness of floral foam blocks 14 or 16.

Flower bundles 36 with their cut stems 22 buried in floral foam blocks 14 and 16, as shown in FIG. 3, are then submersed in soak tank 28. FIG. 4 shows a front view of same. Floral foam blocks 14 and 16 with cut stems 22 inserted are left in soak tank 28 a sufficient time for the floral foam blocks 14 or 16 to become saturated and for cut flower stems 22 to become as fully hydrated as possible. Typically this occurs overnight but would vary with different size bundles and different species of flowers. Soak tank 28 is preferably filled with preservative solution 40. Solution 40 can be of cool water or a mixture of water, nutrients and preservatives.

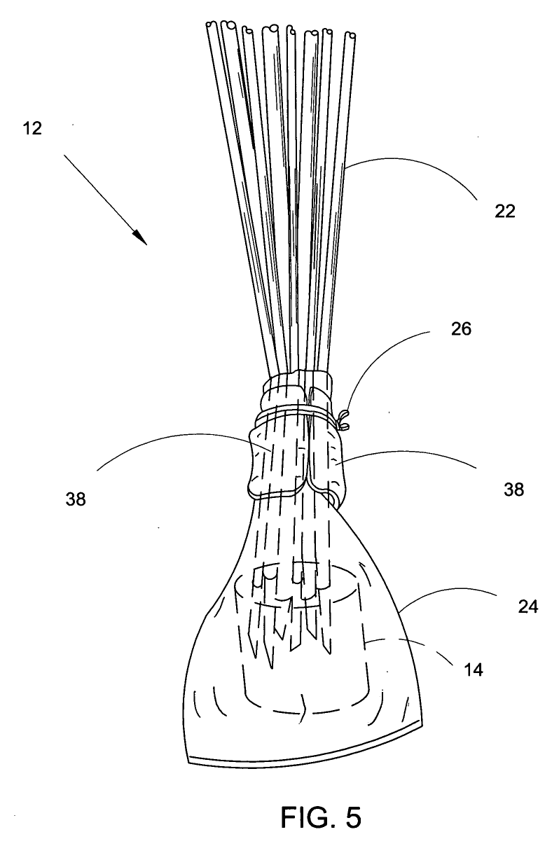

FIG. 5 shows saturated block 14 and 16 with cut flower stems 22 inserted, placed into plastic bag 24 with several preservative packets 38 wrapped around the top of bag 24 and secured by bag top fasteners 26, such as wire ties, string, plastic slip latches or rubber bands. Bag top fasteners 26 also seal the bag top opening of plastic bag 24 tight enough to flower stems 22 to prevent leakage or moisture evaporation, but not so tight as to collapse the moisture carrying capillaries in cut flower stems 22. The hydrated bouquet in Aquapac 12 package is then placed in a shipping container, not shown or part of this invention.

The second preferred embodiment is shown in FIGS. 1D-1F, 2D, 2E and 3-5 is processed in the same manner as the first embodiment above except it provides another step in evaporation prevention. FIG. 1D shows cylindrical floral foam block 14 encased with plastic film sleeve shrink wrap film 18 and processes. FIGS. 1E and 2D show cylindrical and cubical floral foam blocks encased with plastic film seal and shrink wrapping film 20. This operation leaves foam block bottom surface 32 and foam block perimeter walls 34 impervious to moisture and foam block top surface 30 open for insertion of cut flower stems 22. Seal and shrink wrap film 20 on the bottom surface 32 and sleeve shrink wrap films 18 or Seal and shrink wrap film 20 on perimeter walls 34 reduce exposed surface area and proportionally reduce evaporation of absorbed moisture. FIGS. 1F and 2E show drain hole 52 cut in the bottom of the shrink-wrap material to allow any excess preservative solution 40 to drain from foam before it is placed in plastic bag 24 and sealed with bag top fasteners 26.

### Operation:

_Shrink-wrapped foam encasements 54, 56, and 59, plastic bags 24, preservative packets 38 and bag top fasteners 26 are delivered to florist or wholesaler for use in packaging flowers, maximizing their life expectancy. The process of floral insertion, soaking and bagging is then the same as in embodiment 1 above.

The third embodiment replaces the shrink-wrap films 18 and 20 from the second embodiment above with cans or boxes 44 and cans or boxes 45 with drain holes 52 and lids 42 with stem clearance openings 64 through which to insert cut flower stems 22 as shown in FIGS. 1G, 1J, 1K and 2F, 2H and 2J. In this embodiment, floral foam blocks 14 or 16 are inserted into cans or boxes 44 or 45 and lids 42 are attached forming can or box encasements 48, 60 and 62. Either cylindrical cans or cubical boxes 44 or 45 can be easily molded with lids 42 attached to case walls 34 by living hinges or with separate lids 42 attached by any of the standard plastic case lid attachment techniques.

### Operation:

Can or box encasements 48, 60 and 62, plastic bags 24, preservative packets 38 and bag top fasteners 26 are delivered to florist or wholesaler for use in packaging flowers, maximizing their life expectancy.

The additional rigidity of cans or boxes 44 or 45 provides an extra measure of crush or bruise protection to the relatively fragile cut ends of flower stems 22 which must remain open to allow moisture to flow into stems 22 preventing or delaying the onset of stenosis. Bundles of cut flower stems 22 are then inserted through the lid openings 64 and buried into foam blocks 14 or 16.

The processes of soaking, bagging and shipping are then the same as in embodiment 1 above.

The fourth embodiment entails adding stem wells 46 into the floral foam blocks to minimize crushing of the foam material from flower stem insertion as illustrated in FIGS. 1B, 1C, 1H, and 2B, 2C, and 2G.

Addition of stem wells 46 in floral foam blocks 14 and 16 is shown in FIGS. 1B and 2B respectively. Stem wells 46 provide clearance for stems 22, maximizing the moisture absorption capacity of foam blocks 14 or 16 by reducing the crushing of floral foam cells caused by forcing stems 22 into foam blocks. This embodiment entails forming stem wells 46 in a pattern to match the size and number of stems in the intended bundle 36 to be shipped. Stem wells 46 are preferably formed starting at the top surface and progressing to a depth of approximately one half the length of perimeter wall 34. Stem wells 46 preferably have an appropriate diameter such that the stem 22 outside diameters remain in contact with the inside diameter of wells 46 in the moisture bearing floral foam. The pattern of stem wells 46 is such as to keep approximately a 2 cm. clearance to the diameter of lid opening 64 to maintain the stability of foam blocks 14 or 16. Although stem wells 46 can be sized to provide a light slip fit to individual stems 22, they also provide for easier insertion of a bundle of flower stems 36 into the dry foam by giving the foam material displaced by flower stems 22 a space into which it can easily move without being crushed.

FIGS. 1C and 2C show similar modifications to sleeve type and seal and shrink type encasements 57 and 58. FIGS. 1H and 2G show similar modifications to can or box encasements 50 with stem wells 46 that provide similar crush reduction and moisture absorption improvements. Sufficient clearance between the outboard tangents of the well diameters and the ID of the lid opening 64 are required to keep flower stems 22 from riding on the plastic lid 42 edges.

### Operation:

shrink-wrapped foam encasements 57, 58 and can or box encasements 50, plastic bags 24, preservative packets 38 and bag top fasteners 26 are delivered to florist or wholesaler for use in packaging flowers, maximizing their life expectancy.

This embodiment with the individual stem well 46 patterns requires a little more care in the insertion of stems 22 into wells 46 but provides more beneficial contact between the stem walls and the moisture bearing floral foam when the individual stems 22 are inserted into stem wells 46. The ease of insertion of an entire bundle of stems 22 is also enhanced even if the stems 22 do not fit into the well pattern because the foam material displaced by the stems has a space to relocate, provided by the stem wells. After the insertion, the rest of the soaking, bagging and shipping processes are the same as in the previously described embodiments.

Aquapac 12 is described in the above specification by detailing 4 preferred embodiments with exemplary components. These examples are not intended to limit the size or scope of this invention as material selection and size of components are well within the purview of persons skilled in these arts. It is not intended to be limited to this set of materials and dimensions. Rather, the scope of this invention is defined by the following claims:

What is claimed is:

1. A method for shipping bundles of cut flowers comprised of:
providing a bundle of flowers cut for shipment;
providing a supply of plastic bags open at the top;
providing a supply of floral preservative packets;
providing a supply of bag fasteners;
providing a block of floral foam material that has a top surface, a bottom surface, and perimeter walls;
inserting said cut ends of said flowers into said top surface of said blocks of floral foam;
soaking said floral foam blocks with said flower stems inserted in a preservative solution;
placing said soaked floral foam block with said cut flower stems inserted into said plastic bag;
wrapping a plurality of said packets of floral preservative around said bag top; and
securing said preservative packets around said bag top, sealing said bag around said bundle of cut stems with said fasteners.

2. A method for shipping bundles of cut flowers as in claim 1 further comprising:
encasing said perimeter walls and said bottom surfaces of said block of floral foam material wherein said encasement means are selected from a group comprising: plastic film sleeve shrink wrapping, plastic film seal and shrink wrapping or placing floral foam blocks in cans or boxes and attaching lids with stem clearance openings; and
providing optional drain holes in said bottoms of said seal and shrink wrap encasements and in said can or box encasements;

3. A method for shipping bundles of cut flowers as in claim 1 further comprising:
selecting said block of floral foam from predetermined sizes and shapes either with or without clearance wells for stem insertion and of sufficient volume of open cells as to absorb the amount of preservative required to allow said bundle to arrive at its destination hydrated.

4. A method for shipping bundles of cut flowers as in claim 3 further comprising:
providing a pattern of stem wells of sufficient diameter and depth as to either match the size and pattern of the stems to be shipped or patterns that minimize the crushing affect of stem insertion by providing adjacent open space for material displaced by insertion to shift when said stems are not aligned with said stem wells prior to said insertion;
providing said wells at an approximate depth from said top surface as approximately one half the height of said perimeter walls;
providing said wells outer wall tangents at a sufficiently inboard distance from said blocks perimeter walls as to maintain the stability of said foam blocks; and
providing said well outer walls at a sufficiently inboard distance from said blocks perimeter walls as to prevent said cut flower stems abrading against said stem openings in said lids during shipment.

5. A method for shipping bundles of cut flowers as in claim 1 further comprising: selecting said floral preservative solution from the group of plain water, water with floral nutrients, or water with floral preservatives and nutrients.

6. A method for shipping bundles of cut flowers as in claim 1 further comprising: selecting bag top fastener from a group of wire ties, string, rubber bands, or plastic slip latches.
